(19) United States
(12) Patent Application Publication
(10) Pub. No.: US 2011/0107941 A1
(43) Pub. Date: May 12, 2011

(54) COATING MATERIAL FOR ROAD CONSTRUCTION

(75) Inventor: Carlos Vaca-Garcia, Toulouse (FR)

(73) Assignee: INSTITUT NATIONAL POLYTECHNIQUE DE TOULOUSE (INPT), Toulouse Cedex 4 (FR)

(21) Appl. No.: 13/001,435

(22) PCT Filed: Jun. 26, 2009
(86) PCT No.: PCT/EP09/58040

§ 371 Date: Dec. 27, 2010

(30) Foreign Application Priority Data
Jun. 27, 2008 (FR) 08/03638

(51) Int. Cl. C09D 101/10

(52) U.S. Cl. 106/170.57

(57) ABSTRACT

A mixture designed for coating public roads includes: i) a mineral granulate and ii) a non-bituminous binder that is obtained from raw materials of plant origin. The binder consists of a cellulose compound that belongs to the family of cellulose fatty esters. The melting point of the cellulose compound is advantageously between 60° C. and 250° C., preferably between 120° C. and 180° C. The mixture can include between 1% and 20% of binder in content by weight relative to the material, and preferably between 4% and 10%. A process for preparation of a mixture using the binder is also claimed.

This invention belongs to the field of coating materials of public roads, in particular highways and curbs, and more particularly binders for coating granulates designed for road construction and civil engineering.

It has as its object a mixture that comprises a non-bituminous binder, obtained from raw materials of plant origin as well as the binder itself. A process for preparation of a mixture using said binder is also an object of the invention.

The conventional mixtures are mixtures of bitumen (at a level of approximately 5%) with crushed granulates of different sizes, in which the bitumen ensures the link between these different granulates. They can be supplemented or not with elastomers and/or thermoplastic polymers that promote their handling and that improve their viscoelastic behavior. They are primarily used for the construction and maintenance of public roads. This is the case in France, where the bitumens are used at 90% for the production of roads, and at only 10% for industrial uses.

Bitumen is a mixture of hydrogen carbides, obtained from distillation or oxidation, most often in a refinery, of particular qualities of crude oil. Since petroleum is a fossil fuel, bitumen is produced from a non-renewable raw material.

These days, the bituminous mixtures for the construction of highways have to meet new technological requirements, combining properties such as sealing, cohesion, elasticity, insulation, soundproofing, bonding, protection . . . By way of example, the innovative mixtures make it possible to build draining roads, reducing the thickness of the water film on the surface of the coating, retro-reflective roads for better visibility based on climatic conditions, or roads that make it possible to considerably lessen the noise pollution caused by road traffic.

In addition to the large technological dimension of these mixtures based on the different usages for which they are designed, the formulations for road bitumen now have to reduce their environmental impact by recyclability and durability of the materials that are used. First of all, it is necessary to reduce the energy consumption on the road sites, but also to ensure improvement in working conditions of the personnel on the ground, by reducing the emanations of harmful volatile components, and even carcinogenics, and the temperatures for depositing the mixtures. These requirements are all the more necessary as the road traffic, increasingly intense, increases the volumes of bituminous mixtures used in the construction of highways.

The use of raw materials of plant origin can be considered to be a solution for responding to these challenges. The solution that is proposed by this invention is to totally replace the bitumen by a binder that is obtained from a plant raw material, more specifically by a cellulose compound, for producing mixtures that do not contain petrochemical derivatives.

The application FR 2768150 (SAADA) is known that relates to a bitumen-based binder into which an additive of plant origin, playing the role of fluxing agent, is introduced. The fluxing agent is a fatty acid ester that is obtained by transesterification of vegetable oils, in the presence of a polymerization catalyst. The oils that are used are methyl esters of canola oil, flax oil, or sunflower oil, optionally having been previously isomerized.

The application FR 2891838 (COLAS) describes a process for preparation of a non-toxic fluxing agent, based on greases of natural origin, by transesterification by at least one alkanol or a mono-alcohol. This functionalized fluxing agent is used as an additive for the production of a bitumen-based mixture that is designed for road coating and for civil engineering works.

These binders contain compounds of plant origin that play a role of liquefier or bitumen fluxing agent, without replacing the bitumen itself, whereby the latter remains the primary component of the mixture.

The European Application EP 1466878 describes the preparation of binders for the production of roadworks and civil engineering works, starting from resins of plant origin, natural or modified, mixed with a raw or refined vegetable oil, optionally chemically modified and having a determined viscosity. The addition of an emulsifier is necessary for their implementation.

The purpose of this invention is to eliminate the above-mentioned drawbacks without affecting the physico-chemical and mechanical performances of the mixture (mechanical strength, impermeability, . . . ), or the conditions of its implementation in the road applications.

One object of the invention is to offer road coating mixtures, manufactured using a binder formulated from renewable raw materials of plant origin. A particularly desired objective is to propose a non-bituminous road binder, namely a binder totally free of bitumen or other petrochemical substances. Another object of the invention is to use a range of binders for mixtures that have a moderate melting point that allows its softening and its mixing with a granulate without an excessive supply of energy but able to acquire sufficient hardness at the temperatures of use as a road coating. Another object of the invention is to propose a healthier mixture for the individuals handling them, in particular because of the use of binders lacking solvents or other highly volatile harmful compounds at temperatures of use.

Still another object of the invention is to propose a binder that has a good capacity for thermal coating of granules and that has all the characteristics of viscoelasticity as well as the physico-chemical properties that define the bituminous mixtures or the bitumens that are usually used for the coating of highways, so as to be able to prepare it with conventional equipment, without having to invest in a specific installation. Finally, another objective of this invention is to produce a mixture that is durable, recyclable and easy-to-use all at the same time.

The inventors have found that it was possible to produce the above-mentioned objects using a road coating material that uses, as a binder of the granulate, a polymer that consists of a cellulose derivative, more specifically a cellulose fatty ester.

Cellulose, present in the cellular wall of the plants, is the fundamental component of the support tissues of plants. It is the most abundant organic substance on earth and is therefore an infinitely renewable carbon source. This macromolecular biopolymer with very long stereoregular chains formed by links of glucose has a multitude of hydroxyl functions. It is possible to work on these reactive functions to impart to it particular properties with regard to granulates. This reactivity had never been used to produce compositions that can be used in the field of civil engineering. Actually, the fatty esters, i.e., those whose ester group comprises a carbon chain of eight carbon atoms or more, have an apolar nature, unlike shorter esters such as cellulose acetate, which is, by contrast, polar. The mineral granulates, themselves having a polar nature, have a natural affinity for the acetates, the apolar binders being presumed incompatible with a correct adhesion with the granulate.

However, it has appeared that although the cellulose that is esterified by a fatty compound is clearly hydrophobic (unlike the non-grafted cellulose that is clearly hydrophilic or with the above-mentioned polar derivatives), it could, however, have a high and satisfactory affinity with a mineral feedstock whose polar nature is marked. Surprisingly enough, an organic binder that has a good affinity for a mineral granulate has been obtained, with physical and mechanical properties required for the desired application, without it being necessary to add any additive to them. It has also proved advantageous to use the possibility of acting on the degree of substitution to obtain binders of selected rigidity.

Surprisingly enough, it has also appeared that the cellulose fatty esters could totally replace the bitumen in the preparation of the mixtures, which makes it possible to describe these binders as non-bituminous. This binder has turned out to have numerous advantages that make it possible to prepare a new mixture, responding to the specifications disclosed above.

Thus, this invention has as its object a coating material that is intended for road construction and for civil engineering, consisting of a mineral granulate and a non-bituminous binder that consists of a cellulose compound that belongs to the family of cellulose fatty esters.

The reactions for obtaining cellulose esters are known. They can be implemented under defined temperature and reaction duration conditions to end in a total or partial substitution of hydroxyl groups that are present in polysaccharide, according to the desired derivative specifications. The procedure is performed according to one of the known methods that one skilled in the art knows to implement or according to another specifically adapted method. Such methods are described in, for example, the article “Unconventional Methods in Cellulose Functionalization” (T. Heinz et coll., Prog. Polym. Sci., 26 (2001), pp. 1689-1762, Elsevier).

According to an advantageous characteristic of the material according to the invention, the melting point of said cellulose compound is between 60° C. and 250° C., preferably between 120° C. and 180° C. This temperature is the one at which the mixing is usually carried out with the mineral feedstock and the spreading of the mixture.

According to another advantageous characteristic of the material that is the object of the invention, the glass transition temperature of said cellulose compound is between −50° C. and 120° C., preferably between −20° C. and 70° C. The glass transition temperature, denoted Tg, corresponds to the change in state of the polymer under the action of the temperature that produces significant variations of its mechanical properties. The cellulose compounds whose value of the glass transition temperature corresponds to the definition above are selected because they are particularly suitable for an application for a road coating, whereby their Tg is in a range of temperatures that are close to those that a road can experience under different climatic conditions.

The cellulose skeleton of said compound can consist of cellulose that has a degree of polymerization of between 800 and 1,200. It is also possible to use cellulose pastes. According to a preferred embodiment of the binder that is the object of the invention, the cellulose skeleton of said cellulose compound represents 10% to 50% by mass relative to the total mass of said compound, and preferably 20% to 30%.

The hydrophobicity and thermoplasticity properties of the cellulose after modification vary with the nature and the length of the grafted chain and with the degree of substitution. This is why, according to one preferred embodiment of the material that is the object of the invention, said cellulose compound belongs to the family of aliphatic cellulose esters, whose esterifying groups comprise 8 to 18 carbon atoms. These aliphatic esters can be linear or branched. One or the other will be selected according to the flexibility or the rigidity that is desired for the binder.

The cellulose esters are grafted by esterifying chains that totally or partially substitute the hydroxyl groups of the glucose cycles of the cellulose, with a more or less intense degree of substitution DS. Preferably, said cellulose compound is substituted by esterifying groups with a degree of substitution that ranges from 0.9 to 3.0. Each glucose cycle of a cellulose compound can therefore be mono-substituted, di-substituted or tri-substituted.

In one particular embodiment of the material according to the invention, the esterifying groups of the cellulose compound are saturated hydrocarbon radicals that are selected from among the groups whose number of carbon atoms is C₂ₙ, with 4≦n≦9, or a mixture of the latter. After esterification, the cellulose octanoates, the cellulose decanoates, the cellulose laurates, the cellulose myristates, the cellulose palmitates, and the cellulose stearates are obtained.

In another particular embodiment of the binder according to the invention, the esterifying groups of the cellulose compound are unsaturated hydrocarbon radicals that are selected from among the groups of which the carbon atom number is C₂ₙ , with n=9, and of which the number of unsaturated bonds is i=1 or 2, or a mixture of the latter. In this case, the oleic acid C18:1 or the linoleic acid C18:2 is used as an esterifying agent.

Finally, in the material according to the invention, the cellulose compound can be a mixed ester that comprises different esterifying groups, saturated or unsaturated, as defined above.

The modification of the hydroxyl groups of cellulose into aliphatic long-chain esters modifies and considerably improves the bioresistance, the solubility, but primarily in our case, the hydrophobicity and the thermoplasticity of the cellulose, making it suitable for use as a binder for a coating material for roads and public roads.

The characteristics of the road coating material according to the invention partially result from those of the binder as has been explained above. It is also characterized by the mixing of its ingredients. Thus, the material according to the invention can advantageously comprise between 1% and 20% of binder in a content by weight that is related to the material. Preferably, it comprises between 4% and 10% of binder.

The non-bituminous mixture according to the invention can be prepared by mixing the binder with sand and/or gravel with a grain size that is suitable for the use provided, by following the procedure that is commonly used for the preparation of conventional bituminous mixtures. The equipment of the professionals therefore does not have to be changed or modified.

Spreading tests on soil have shown that this mixture spreads as easily as a bituminous mixture and that in addition, it is much easier to handle because it does not bond to tools or to shoes. By so doing, it hardens at least as quickly.

The non-bituminous coating material is therefore particularly suitable for the production of a road coating. Thus, a process for preparation of a coating material that is designed for road construction and for civil engineering is the object of the invention, according to which a mineral granulate (may be a recycled material) and a non-bituminous binder that consists of a cellulose compound belonging to the family of cellulose fatty esters as described above are mixed at a temperature that is higher than the melting point of said binder.

This invention will be better understood, and details revealing it will be provided, based on the description that will be given from different variant embodiments.

### Example 1

Synthesis of a Non-Bituminous Binder

### 1) Cellulose Trioctanoate

The esterification reaction of the cellulose is carried out by reacting the a-type cellulose with a powerful esterification agent, namely a carboxylic acid chloride with eight carbon atoms, octanoyl chloride. The reaction is conducted until the total substitution of the hydroxyl groups of the cellulose by the octanoyl esterifying chains is completed, or a degree of substitution DS=3 is reached, to obtain the corresponding trioctanoate.

### Products Used:

| Name | Data | Quantity |
|---|---|---|
| α Cellulose (Aldrich) | CAS: 9004-34-6 | 20 g (0.345 mol) |
| | M = 162 g/mol | |
| | 7% Moisture | |
| 99% Octanoyl Chloride | CAS: 111-64-8 | 0.1181 |
| (Aldrich) | d = 0.953 | (2 equivalents per OH) |
| | M = 162.66 g/mol | |

Obtaining cellulose trioctanoate is confirmed by elementary analysis.

2) Cellulose Octanoate with DS Less than 3

Cellulose octanoates with different degrees of substitution have been synthesized by varying the quantity of octanoyl chloride added relative to the initial quantity of cellulose in the reactor (between 1.0 and 1.5 equivalents per OH).

Octanoates of DS=2.4 and DS=1.9, confirmed by elementary analysis, are obtained.

### 3) Characterization

The glass transition temperature Tg of the esters obtained has been determined by DMTA (Dynamic-Mechanical Thermal Analysis), and the melting point Tf by tests for obtaining films by thermopressing. The different results are presented in Table 1.

TABLE 1
Degree of Substitution, Glass Transition Temperature, and
Melting Point of the Different Cellulose Octanoates Obtained

| DS | Tg | Tf |
|---|---|---|
| 3.0 | 46° C. | 60° C. |
| 2.4 | 49° C. | 70° C. |
| 1.9 | 80° C. | >200° C. |

We note that for a DS of 3 and 2.4, a relatively low value of Tf is obtained with, at the same time, thermopressed films starting from 60° C. The implementation of these esters is easier than that of the ester with DS 1.9, whose melting point is higher.

### Example 2

Other Formulations

### 1) Cellulose Laurate and Stearate

Other binders have been synthesized according to the same process as above, by varying the nature of the fatty chain and the degree of substitution. The esterification reaction of the α-type cellulose was carried out with carboxylic acid chlorides with 12 and 18 carbon atoms (lauroyl chloride and stearoyl chloride). The reaction was conducted in such a way as to obtain different degrees of substitution of the hydroxyl groups of the cellulose by the esterifying chains.

### Products Used:

| Name | Data | Quantity |
|---|---|---|
| α Cellulose (Aldrich) | CAS: 9004-34-6 | 10 g (0.172 mol) |
| | M = 162 g/mol | |
| | 7% Moisture | |
| 99% Lauroyl Chloride | CAS: 112-16-3 | Between 0.5 and 2.5 |
| (Aldrich) | d = 0.946 | Equivalents per OH |
| | M = 218.76 g/mol | |
| 98% Stearoyl Chloride | CAS: 112-76-5 | Between 0.5 and 2.5 |
| (Fluka) | d = 0.897 | Equivalents per OH |
| | M = 302.92 | |

Obtaining cellulose laurate and cellulose stearate is confirmed by elementary analysis. The degrees of substitution that are obtained are recorded in Table 2.

TABLE 2
Cellulose Esters and Degrees of Substitution

| Name | Degree of Substitution |
|---|---|
| Cellulose Laurate | 3 |
| | 2.1 |
| | 0.6 |
| Cellulose Stearate | 2.9 |
| | 1.7 |
| | 0.5 |

### 2)-Characterization

The glass transition temperature Tg was determined by DMTA (Dynamic-Mechanical Thermal Analysis), and the melting point Tf was determined by tests for obtaining films by thermopressing. The different results are presented in Table 3.

We note that for relatively high DS, we have relatively low Tg values.

TABLE 3
Degree of Substitution, Glass Transition Temperature, and Melting
Point of Different Cellulose Laurates and Stearates Obtained

| Name | DS | Tg | Tf |
|---|---|---|---|
| Cellulose Laurate | 3.0 | 40° C. | 45° C. |
| | 2.1 | 50° C. | 90° C. |
| | 0.6 | >200° C. | >200° C. |
| Cellulose Stearate | 2.9 | 45° C. | 50° C. |
| | 1.7 | 60° C. | 90° C. |
| | 0.5 | >200° C. | >200° C. |

### Example 3

Non-Bituminous Mixture

A non-bituminous mixture has been prepared under production conditions (500 kg) from a binder that consists of cellulose octanoate comprising 30% cellulose with a degree of substitution DS=3, as described in Example 1, and a porphyrous-type granulate. The granulate and the binder have been mixed at a proportion of 94/6, for 2 minutes, at the temperature of 170° C. A dark-gray pasty mixture is obtained.

The thus obtained mixture was dumped on a highway and spread with a shovel, and then compacted using a compressor roller. It was noted that its maneuverability and its viscoelastic behavior were entirely comparable to those of the conventional mixtures. To the great satisfaction of the operators, it appeared that the manipulation of the coating was facilitated because it was not very adhesive, making it possible to walk on top of it without difficulty but also making the use and cleaning of tools easier. The odor that was released recalled that of hot oil but not that of bituminous compounds. After several hours, the observation of the evolution of the consistency of the layer showed that its hardening took place normally.

One test has also been carried out by mixing the preceding binder with a limestone mineral feedstock, in the proportion of K92/L8. The same results as above could be observed in the mixture.

Another mixture was prepared from cellulose laurate having a degree of substitution of DS=3, mixed with a porphyrous-type mineral feedstock. The results of quality that are obtained are the same as above.

1-11. (canceled)

12. Coating material that is designed for road construction and civil engineering, characterized in that it consists of i) a mineral granulate and ii) a non-bituminous binder that consists of a cellulose compound that belongs to the family of cellulose fatty esters.

13. Coating material according to claim 12, wherein the melting point of said cellulose compound is between 60° C. and 250° C., preferably between 120° C. and 180° C.

14. Coating material according to claim 12, wherein the glass transition temperature of said cellulose compound is between −50° C. and 120° C., preferably between −20° C. and 70° C.

15. Coating material according to claim 12, wherein the cellulose skeleton of said cellulose compound represents 10% to 50% by mass relative to the total mass of said compound, and preferably 20% to 30%.

16. Coating material according to claim 12, wherein said cellulose compound belongs to the family of aliphatic cellulose esters, whose esterifying groups comprise 8 to 18 carbon atoms.

17. Coating material according to claim 16, wherein said cellulose compound is substituted by esterifying groups with a degree of substitution that ranges from 0.9 to 3.0.

18. Coating material according to claim 12, wherein the esterifying groups of the cellulose compound are saturated hydrocarbon radicals that are selected from among the groups whose carbon atom number is C₂ₙ, with 4≦n≦9, or a mixture of the latter.

19. Coating material according to claim 18, wherein the esterifying groups of the cellulose compound are unsaturated hydrocarbon radicals that are selected from among groups whose carbon atom number is C₂ₙ, with n=9, and whose number of unsaturated bonds is i=1 or 2, or a mixture of the latter.

20. Coating material according to claim 19, wherein the cellulose compound is a mixed ester that comprises the different esterifying groups, saturated or unsaturated.

21. Material according to claim 12, wherein it comprises between 1 and 20% of binder, preferably between 4% and 10% of binder, of content by weight relative to the material.

22. Process for preparation of a coating material that is designed for road construction and civil engineering according to claim 12, wherein a mineral granulate and a non-bituminous binder that consists of a cellulose compound that belongs to the family of cellulose fatty esters are mixed at a temperature that is higher than the melting point of said binder.

23. Coating material according to claim 13, wherein the glass transition temperature of said cellulose compound is between −50° C. and 120° C., preferably between −20° C. and 70° C.

24. Coating material according to claim 12, wherein the esterifying groups of the cellulose compound are unsaturated hydrocarbon radicals that are selected from among groups whose carbon atom number is C₂ₙ, with n=9, and whose number of unsaturated bonds is i=1 or 2, or a mixture of the latter.
